(19) United States
(12) Patent Application Publication
(10) Pub. No.: US 2007/0130963 A1
(43) Pub. Date: Jun. 14, 2007

(54) APPARATUS AND PROCESS FOR VAPORIZING LIQUEFIED NATURAL GAS

(76) Inventors: Denby Grey Morrison, Houston, TX (US); William Alexander Hunter, Katy, TX (US); Allen Melvyn Brooks, Kuala Lumpur (MY); Kris Andrew Digre, Conroe, TX (US); Gregory John Koehler, Houston, TX (US)

Correspondence Address: SHELL OIL COMPANY, P O BOX 2463, HOUSTON, TX, 772522463, US

(21) Appl. No.: 11/466,207

(22) Filed: Aug. 22, 2006

Related U.S. Application Data
(60) Provisional application No. 60/710,662, filed on Aug. 23, 2005.

(51) Int. Cl. F17C 9/02; F25D 23/12

(52) U.S. Cl. 62/50.2; 62/260

(57) ABSTRACT

The invention provides for an apparatus and process for vaporizing liquefied natural gas using groundwater. The invention provides for an apparatus including: a groundwater well; a vaporizer for vaporizing LNG; and an LNG tank. The invention also provides for a process including vaporizing LNG in a vaporizer using groundwater.

### CROSS-REFERENCE TO RELATED APPLICATIONS

This application claims the benefit of U.S. Provisional Application No. 60/710,662, filed Aug. 23, 2005, which is incorporated herein by reference.

### FIELD OF THE INVENTION

The invention relates to an apparatus and process for vaporizing liquefied natural gas.

### BACKGROUND OF THE INVENTION

Natural gas may be stored and transported in a liquefied form. In the liquefied form, the liquefied natural gas occupies a volume of approximately 1/600th that of natural gas. Liquefied natural gas (“LNG”) is a colorless, odorless liquid normally stored and transported in insulated tanks at a temperature of about minus 160 degrees Celsius (−160° C.) and near atmospheric pressure. In order to use the LNG as a fuel or feedstock, the LNG must be converted from the cold liquefied form back to the natural gas vapor state at or near ambient temperature. The process to convert the LNG to natural gas is referred to as vaporization that requires heat in order to vaporize the LNG until the LNG turns into natural gas in the vapor state.

Clean-burning natural gas can help meet a growing world-wide demand for energy. Residential use consumes large quantities of natural gas for heating, cooling, and cooking. Industry and the business sector also consume large quantities of natural gas. Natural gas can be used to generate electricity in power plants. Natural gas also serves as the raw material to make paint, plastics, fertilizer, steel, fabrics, glass, and numerous other products. The demand for natural gas is expected to continue increasing. Natural gas is normally transported by pipeline. An advantage of LNG is that LNG may be transported by ship to and from overseas markets further than would be practical with pipelines. Transporting LNG by ship allows customers who live or operate a long way from gas reserves to enjoy the benefits of natural gas. Importing LNG by ships has led to the establishment of LNG storage and vaporization facilities in many countries around the world. To serve the increase in natural gas demand, additional LNG storage and vaporization facilities will be required.

There are several methods available for the vaporization of LNG into natural gas, but the methods can be generally categorized as those that use water as a warming medium and those that burn a portion of the natural gas as fuel in order to provide heat to the vaporization process. Processes that use air as the warming medium are still considered generally unproven and in some circumstances are considered impractical.

Methods of vaporization of LNG into natural gas that utilize water as a warming medium generally utilize large quantities of water that must be withdrawn from a body of water, for example, lakes, rivers, seas, oceans, and combinations thereof, and then returned to the body of water after using the water for LNG vaporization. In addition, withdrawing large quantities of water from a body of water and/or returning large quantities of water to a body of water may affect the body of water and marine organisms of the body of water.

Thus, there is a need for an apparatus and process for the vaporization of LNG into natural gas that reduces the quantity of water that is withdrawn from a body of water. There is also a need for an apparatus and process for the vaporization of LNG into natural gas that reduces the quantity of water that is returned to a body of water.

### SUMMARY OF THE INVENTION

The invention provides for an apparatus comprising: a groundwater well; a vaporizer for vaporizing LNG; and an LNG tank.

The invention also provides for a process comprising vaporizing LNG in a vaporizer using groundwater.

### BRIEF DESCRIPTION OF THE DRAWINGS

One or more embodiments of the invention are described in detail and by way of example only with reference to the accompanying drawings.

FIG. 1 schematically depicts an apparatus of the invention utilized onshore.

FIG. 2 schematically depicts an apparatus of the invention utilized offshore.

FIG. 3 depicts a plan view of an apparatus of the invention.

### DETAILED DESCRIPTION OF THE INVENTION

The invention generally comprises a groundwater well, also referred to in the art as a groundwater production well or producer, that provides groundwater from an underground source of water. The groundwater from the groundwater well is directed to an LNG vaporization process comprising a vaporizer where LNG is vaporized by the groundwater to provide for natural gas.

An advantage of the invention may be a reduction of the quantities of water that are withdrawn from a body of water for use in an LNG vaporization process.

Another advantage of the invention may be a reduction of the quantities of water from an LNG vaporization process that are returned to a body of water.

Another advantage of the invention may be a reduction of the quantities of water utilized to vaporize LNG by utilizing groundwater that may be at a higher temperature than water from a body of water.

In addition, reducing the quantities of water that are withdrawn from a body of water and/or returned to a body of water may reduce the effect on the body of water and marine organisms of the body of water.

Examples of a body of water include, but are not limited to, lakes, rivers, seas, oceans, and combinations thereof.

Examples of groundwater include, but are not limited to, water from underground and water from within the earth.

Directing the groundwater to the vaporizer may be accomplished using a means for pumping groundwater. A means for pumping groundwater may also help meet the boosting needs in the groundwater well. Examples of a suitable means for pumping groundwater include, but are not limited to, electrical submersible pumps, surface driven pumps, and combinations thereof. Depending on the depth of the groundwater well, a means for pumping groundwater may not be needed. For example, in a shallow well that may be a few hundred meters deep, the pressure may be low enough that a means for pumping groundwater may be needed. In a deeper well that may be a few thousand meters deep, the pressure may be high enough that a means for pumping groundwater may not be needed.

A vaporizer of the invention may be any vaporizer that suitably provides for a vaporizing of LNG utilizing the heat provided by the groundwater according to a process of the invention. Examples of a suitable vaporizer include, but are not limited to, open rack vaporizers, shell-and-tube vaporizers, and combinations thereof.

The vaporizer transfers heat from the groundwater to the LNG and thus raises the LNG temperature and heat content such that the LNG vaporizes into natural gas. In the vaporization process, the groundwater is cooled by an amount depending on the flow rates of the groundwater and LNG. The groundwater from the vaporizer may then be sent to a desired location. For example, the groundwater from the vaporizer may be sent to a body of water generally adjacent to an LNG vaporization facility that comprises the vaporizer.

When returning the groundwater from the vaporizer to a body of water is, for example, impractical, prevented by regulation, and combinations thereof, a groundwater injection well may be located for the purpose of returning the groundwater back into the ground. The groundwater injection well may be located on land or over water in offshore applications, for example, offshore LNG terminals.

Injecting groundwater from the vaporizer into a groundwater injection well may be accomplished using any means for injecting groundwater. Examples of suitable means for injecting groundwater from the vaporizer include, but are not limited to, water injection pumps. The water injection pumps may be, for example, but not limited to, electrically or mechanically driven. The water injection pumps may be, for example, submersible or above the surface of a body of water.

The groundwater well is generally located at a groundwater well location that may be any location that suitably provides for groundwater. Examples of a suitable groundwater well location include, but are not limited to, onshore, offshore, and combinations thereof. The groundwater well is generally located underground, preferably in an underground porous and permeable subsurface rock formation.

The groundwater injection well is generally located at a groundwater injection well location that may be any location that suitably provides for groundwater injection. Examples of a suitable groundwater injection well location include, but are not limited to, onshore, offshore, and combinations thereof. The groundwater injection well is generally located underground, preferably in an underground porous and permeable subsurface rock formation.

Natural gas from the vaporizer may be directed to a natural gas pipeline. The natural gas pipeline may be connected to an export metering system. The natural gas pipeline may be connected with other pipelines, heaters, and other equipment and apparatus typically utilized in the transport of natural gas.

An apparatus and process of the invention may be utilized where the groundwater from a groundwater well is the sole source of water for the vaporization process. Alternatively, an apparatus and process of the invention may be utilized where the groundwater from a groundwater well is utilized to augment a supply of water from another source for example, but not limited to, from a body of water including, but not limited to, lakes, rivers, seas, oceans, and combinations thereof, in order to reduce the quantity of water required to be withdrawn from a body of water.

An apparatus of the invention may further comprise an LNG storage tank and a means for pumping the LNG from the LNG storage tank to the vaporizer. The LNG storage tank, also referred to as an LNG tank, may be any LNG tank typically utilized to store LNG. The LNG tank may be of any size, shape, and material that suitably provides for the storage of LNG. Examples of a suitable LNG tank include, but are not limited to, 9% nickel steel cylindrical tanks, membrane tanks, SPB (Self-supporting Prismatic shape IMO Type “B”) tanks, and combinations thereof. The LNG tank may be located onshore, offshore, and combinations thereof.

Examples of a suitable means for pumping LNG from the LNG tank to the vaporizer include, but are not limited to, low pressure pumps, high pressure pumps, and combinations thereof. An example suitable means for pumping comprises a low pressure pump located in the LNG tank that pumps LNG to a high pressure pump located between the low pressure pump and the vaporizer. The high pressure pump provides pressure for pumping the LNG through the vaporizer and for transporting the produced natural gas through a natural gas pipeline.

An apparatus and process of the invention may be utilized with a variety of onshore LNG vaporization facilities, offshore LNG vaporization facilities, and combinations thereof. An apparatus and process of the invention may be utilized with a variety of offshore LNG vaporization facilities including, but not limited to, offshore platforms, steel fixed jackets, floating vessels, concrete gravity base structures, steel gravity base structures, and combinations thereof.

An apparatus and process of the invention provides for flexibility in vaporizing LNG with groundwater. For example, when an onshore LNG vaporization facility is utilized, a groundwater well, a groundwater injection well, and combinations thereof, may be located onshore, offshore, and combinations thereof. For example, when an onshore LNG vaporization facility is utilized, a groundwater well and a groundwater injection well may both be located onshore. Also for example, when an onshore LNG vaporization facility is utilized, a groundwater well and a groundwater injection well may both be located offshore. Also for example, when an onshore LNG vaporization facility is utilized, a groundwater well may be located onshore and a groundwater injection well may be located offshore. Also for example, when an onshore LNG vaporization facility is utilized, a groundwater well may be located offshore and a groundwater injection well may be located onshore.

Also for example, when an onshore LNG vaporization facility and two groundwater wells, two groundwater injection wells, and combinations thereof are utilized, one of the two wells may be located onshore and the other may be located offshore. For example, when an onshore LNG vaporization facility is utilized, one groundwater well may be located onshore and the other groundwater well may be located offshore. Also for example, when an onshore LNG vaporization facility is utilized, one groundwater injection well may be located onshore and the other groundwater injection well may be located offshore.

When an offshore LNG vaporization facility is utilized, non-limiting example arrangements similar to the non-limiting example arrangements disclosed herein for an onshore LNG vaporization facility are possible. For example, when an offshore LNG vaporization facility is utilized, a groundwater well, a groundwater injection well, and combinations thereof, may be located onshore, offshore, and combinations thereof. For example, when an offshore LNG vaporization facility is utilized, a groundwater well and a groundwater injection well may both be located offshore. Also for example, when an offshore LNG vaporization facility is utilized, a groundwater well and a groundwater injection well may both be located onshore. Also for example, when an offshore LNG vaporization facility is utilized, a groundwater well may be located offshore and a groundwater injection well may be located onshore. Also for example, when an offshore LNG vaporization facility is utilized, a groundwater well may be located onshore and a groundwater injection well may be located offshore.

Also for example, when an offshore LNG vaporization facility and two groundwater wells, two groundwater injection wells, and combinations thereof are utilized, one of the two wells may be located offshore and the other may be located onshore. For example, when an offshore LNG vaporization facility is utilized, one groundwater well may be located offshore and the other groundwater well may be located onshore. Also for example, when an offshore LNG vaporization facility is utilized, one groundwater injection well may be located offshore and the other groundwater injection well may be located onshore.

One can see from the non-limiting examples disclosed herein, that a number of potential locations and options may be utilized when utilizing an apparatus and process of the invention. An apparatus and process of the invention may provide for flexibility depending on the location of the LNG vaporization facilities, the source of the groundwater, and the desired location for returning the groundwater from the vaporizer.

The number of wells, for example, groundwater wells, groundwater injection wells, and combinations thereof, may be any number that provides for a process of the invention. The number of wells and supporting utilities may be sized to meet the quantities of groundwater required for vaporizing the LNG. The number of wells may provide for redundancy and for alternate use, simultaneous use, and combinations thereof. For example, one groundwater well may be taken off-line for maintenance while another groundwater well may be in operation.

The depth and size of the wells, for example, groundwater wells, groundwater injection wells, and combinations thereof, may be adjusted depending on the heat in the groundwater and the properties of the wells. The depth and size of the wells may be any size and depth that suitably provides for a process of the invention. The depth and size of a groundwater well may be any size and depth that suitably provides for sufficient quantities of water for the vaporization of LNG to provide for natural gas. The depth and size of a groundwater injection well may be any size and depth that suitably provides for the injecting of quantities of water utilized in the vaporization of LNG to provide for natural gas.

The depth of a groundwater well is generally in a range of from about a depth where groundwater may be obtained down to about 7500 meters. A depth of a groundwater well is generally in a range of from about 30 meters to about 7500 meters, preferably in a range of from about 150 meters to about 6000 meters, and more preferably in a range of from about 300 meters to about 4500 meters.

The depth of a groundwater injection well is generally in a range of from about a depth where groundwater may be suitably injected down to about 7500 meters. A depth of a groundwater injection well is generally in a range of from about 30 meters to about 7500 meters, preferably in a range of from about 150 meters to about 6000 meters, and more preferably in a range of from about 300 meters to about 4500 meters.

When a well, for example, a groundwater well or a groundwater injection well, is located onshore, the well is located underground, in other words, below the surface of the ground. When a well, for example, a groundwater well or a groundwater injection well, is located offshore, the well is located below the bottom surface of the body of water. In other words, the well is located below the ground at the bottom of the body of water. For example, when the body of water is the sea, the well is located below the sea floor. Also for example, when the body of water is the ocean, the well is located below the ocean floor. The floor of a sea or ocean may also be referred to as the “mud line”. Locating a well below the floor of a sea or ocean may also be referred to as locating a well below the mud line.

Locating a well, for example, a groundwater well or a groundwater injection well, generally comprises drilling. Drilling may utilize any means for drilling that provides for an apparatus and process of the invention. Examples of suitable means for drilling include, but are not limited to, drilling rigs located on an LNG facility, self-contained mobile drilling units, and combinations thereof.

The bottom section of each well is generally located at a “bottom hole location”. Depending on the various drilling techniques that may be utilized, the top sections of the wells described herein may be at one central position whereas the bottom hole locations of the wells may be at different positions. For example, if directional drilling is utilized, the top sections of a groundwater well and a groundwater injection well may be at the same general location, for example, at one side of an LNG facility, and the bottom hole locations of the wells may be different. The bottom hole location of a well, for example, a groundwater well or a groundwater injection well, is generally underground, preferably in an underground porous and permeable subsurface rock formation.

When the well is located offshore, the LNG vaporization facility may be used to support the well. For example, when the LNG vaporization facility comprises a Gravity Base Structure (GBS), the well may be supported by, or attached to, the structure. Alternatively, the well may be supported by independent structures, for example, but not limited to, offshore platform jackets. The well may be supported by a combination of independent structures and attachments to the LNG vaporization facility.

A well, for example, a groundwater well or a groundwater injection well, may be maintained by any means that suitably maintains the wells for use in an apparatus and process of the invention. Examples of suitable means for maintaining a well include, but are not limited to, equipment installed on the LNG facility, mobile well service units, drilling rigs, and combinations thereof.

The LNG storage facilities and the LNG vaporization facilities may be located at the same location or at different locations. The term “LNG facility” refers to LNG storage facilities, LNG vaporization facilities, and combinations thereof. Generally, the LNG storage facility and the LNG vaporization facility may be combined as one facility.

Generally, the groundwater well and the vaporizer are in fluid communication. Generally, the LNG tank and the vaporizer are in fluid communication. Generally, the vaporizer and the groundwater injection well are in fluid communication. Any means for providing for fluid communication typical in the art may be utilized including, but not limited to, piping, conduit, valves, metering devices, and combinations thereof. The means for providing for fluid communication may be insulated, for example, but not limited to, by vacuum insulation.

An apparatus of the invention may also comprise other components used in vaporizing LNG into natural gas. Examples of other components include, but are not limited to, boil-off gas compressors, suction drums, controls, flares, vents, and combinations thereof.

A process of the invention generally comprises vaporizing LNG in a vaporizer using groundwater. A process of the invention may further comprise pumping groundwater from a groundwater well to the vaporizer. A process of the invention may further comprise pumping LNG from an LNG tank to the vaporizer. A process of the invention may further comprise injecting the groundwater from the vaporizer into a groundwater injection well. A process of the invention may further comprise passing the natural gas from the vaporizer to a natural gas pipeline. The groundwater well may be located underground, preferably in an underground porous and permeable subsurface rock formation. The groundwater injection well may be located underground, preferably in an underground porous and permeable subsurface rock formation. The groundwater well may be at a groundwater well location selected from the group consisting of onshore, offshore, and combinations thereof. The groundwater injection well may be at a groundwater injection well location selected from the group consisting of onshore, offshore, and combinations thereof.

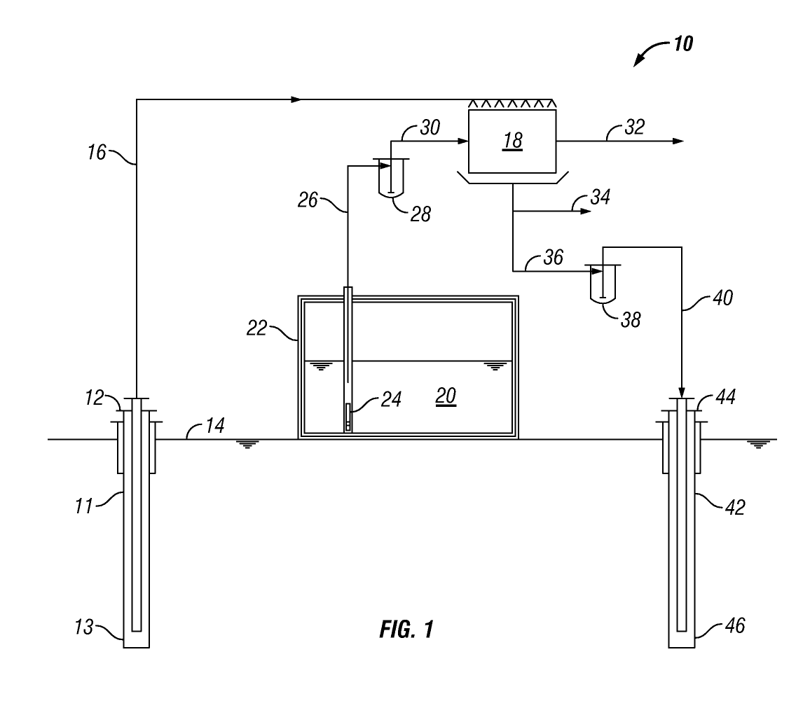

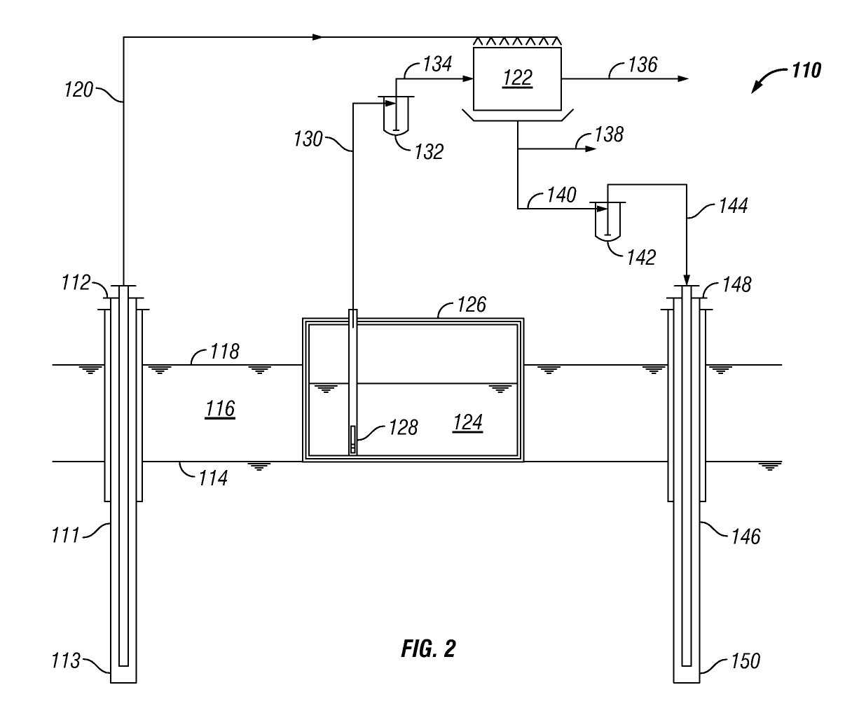

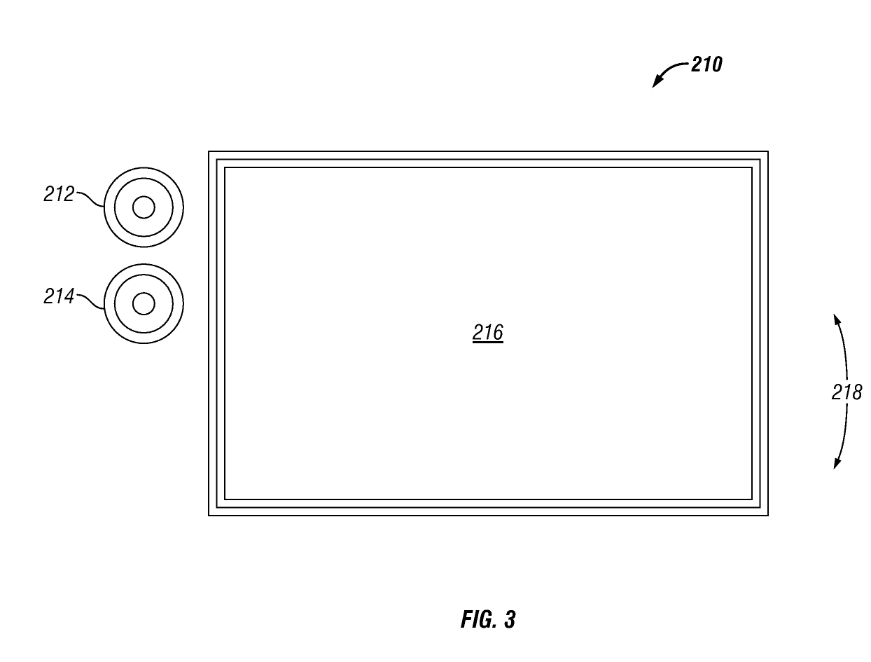

FIG. 1, FIG. 2, and FIG. 3 disclose an apparatus of the invention. For the sake of clarity, typical components utilized in vaporizing LNG into natural gas, for example, but not limited to, valves, metering devices, boil-off gas compressors, suction drums, controls, flares, vents, and combinations thereof have been omitted.

Referring to FIG. 1, an apparatus 10 of the invention located onshore is disclosed. In FIG. 1, groundwater well 11 is located below the surface of ground 14. Groundwater well 11 comprises a top section 12 and a bottom section 13. Top section 12 is located above the surface of ground 14. Bottom section 13 is located below the surface of ground 14. Groundwater from groundwater well 11 is directed via conduit 16 to vaporizer 18. Boosting needs in groundwater well 11 and directing the groundwater to vaporizer 18 is accomplished using a means for pumping groundwater (not shown) as described herein. LNG 20 is stored in insulated LNG storage tank 22 and is pumped from LNG storage tank 22 by means for pumping LNG comprising a low pressure pump 24 and a high pressure pump 28. Low pressure pump 24 and high pressure pump 28 are connected via conduit 26. High pressure pump 28 boosts the pressure of LNG 20 and directs LNG 20 to vaporizer 18 via conduit 30. In vaporizer 18, LNG 20 is vaporized using groundwater from groundwater well 11 to provide for natural gas. The natural gas is passed to natural gas pipeline 32 for sending the natural gas to a desired location. The groundwater utilized in vaporizer 18 to vaporize LNG 20 exits vaporizer 18 and may be passed via conduit 34 to a body of water. In addition to, or in lieu of, passing the groundwater to a body of water, the groundwater may be injected via conduit 36 using a means for injecting groundwater comprising a water injection pump 38 for injecting the groundwater into groundwater injection well 42 via conduit 40. Groundwater injection well 42 is located below the surface of ground 14. Groundwater injection well 42 comprises a top section 44 and a bottom section 46. Top section 44 is located above the surface of ground 14. Bottom section 46 is located below the surface of ground 14.

Referring to FIG. 2, an apparatus 110 of the invention located offshore is disclosed. In FIG. 2, groundwater well 111 is located below bottom surface 114 of body of water 116 having a top surface 118. Groundwater well 111 comprises a top section 112 and a bottom section 113. Top section 112 is located above top surface 118. Bottom section 113 is located below bottom surface 114. Groundwater from groundwater well 111 is directed via conduit 120 to vaporizer 122. Boosting needs in groundwater well 111 and directing the groundwater to vaporizer 122 is accomplished using a means for pumping groundwater (not shown) as described herein. LNG 124 is stored in insulated LNG storage tank 126 and is pumped from LNG storage tank 126 by means for pumping LNG comprising a low pressure pump 128 and a high pressure pump 132. Low pressure pump 128 and high pressure pump 132 are connected via conduit 130. High pressure pump 132 boosts the pressure of LNG 124 and directs LNG 124 to vaporizer 122 via conduit 134. In vaporizer 122, LNG 124 is vaporized using groundwater from groundwater well 111 to provide for natural gas. The natural gas is passed to natural gas pipeline 136 for sending the natural gas to a desired location. The groundwater utilized in vaporizer 122 to vaporize LNG 124 exits vaporizer 122 and may be passed via conduit 138 to a body of water. In addition to, or in lieu of, passing the groundwater to a body of water, the groundwater may be injected via conduit 140 using a means for injecting groundwater comprising a water injection pump 142 for injecting the groundwater into groundwater injection well 146 via conduit 144. Groundwater injection well 146 is located below bottom surface 114 of body of water 116 having top surface 118. Groundwater injection well 146 comprises a top section 148 and a bottom section 150. Top section 148 is located above top surface 118. Bottom section 150 is located below bottom surface 114.

Referring to FIG. 3, a plan view 210 of an apparatus of the invention is disclosed. Groundwater well 212 and groundwater injection well 214 may be located adjacent to LNG facility 216. The area 218 around LNG facility 216 may be land, for example, when LNG facility 216 is located onshore. Also for example, the area 218 around LNG facility 216 may be a body of water, for example, when LNG facility 216 is located offshore.

### EXAMPLE

The following example is a hypothetical design analysis of using groundwater as a warming medium for an offshore Gravity Base Structure (GBS). The groundwater flow rate is approximately 48,000,000 liters per day with a ten (10) degree Celsius temperature differential. The temperature differential is the difference in temperature between the groundwater from the groundwater well before entering the vaporizer and the temperature of the groundwater exiting the vaporizer to be, for example, injected into a groundwater injection well. Typical water injection systems may be from about 8,000,000 liters per day to about 24,000,000 liters per day. Groundwater flow rate is directly proportional to the temperature differential so with a higher temperature differential available, the flow rate may be decreased. Table 1 is an example table of temperature differentials and approximate required flow rates.

TABLE 1

| | Approximate Flow Rate |
|---|---|
| Temperature Differential | Required |
| (degrees Celsius) | (liters per day) |
| 10 | 48,000,000 |
| 20 | 24,000,000 |
| 30 | 16,000,000 |
| 40 | 12,000,000 |
| 50 | 9,600,000 |
| 60 | 8,000,000 |
| 70 | 6,880,000 |
| 80 | 6,000,000 |
| 100 | 4,800,000 |

A groundwater well and a means for pumping groundwater, for example, one or more electrical submersible pumps, would typically be capable of groundwater production rates in a range of from about 3,200,000 liters per day to about 6,400,000 liters per day.

Shallow wells would typically produce at lower temperatures so more wells would be needed. Deeper wells would typically produce at higher temperatures so fewer wells would be needed, but the costs of the wells generally increases with well depth.

The temperature below the mud line generally increases with depth. Typically, the temperature would be about 10 degrees Celsius at the mud line plus about 0.55 to about 0.67 degrees Celsius per 30 meters of well depth. Table 2 discloses an example of depth and normal temperatures. The phrase “BML” in Table 2 refers to below the mud line.

TABLE 2

| | | Extreme |
|---|---|---|
| | Normal Temperature | Temperature |
| Depth BML | Range | (degrees |
| (meters) | (degrees Celsius) | Celsius) |
| 1500 | 37-43 | — |
| 3000 | 65-77 | — |
| 4500 | 92-110 | 150 |
| 6000 | 120-144 | 230 |
| 7500 | 147-177 | — |

Abnormally high temperatures may occur in some locations, typically below about 4500 meters. In some areas, for example, but not limited to, the Gulf of Mexico offshore continental shelf, the temperatures may reach about 150 degrees Celsius at about 4500 meters and about 230 degrees Celsius at about 6000 meters. Such deep depth locations would be more challenging to drill and operate and thus, would generally be more expensive than a more shallow depth location.

The surface temperature, also referred to in the art as flowing tubing head temperature, should be lower by about 30 degrees Celsius when the groundwater well is in operation. Vacuum-insulated tubing or other insulation means may be used to help maintain the temperature of the groundwater as the groundwater flows up the well bore.

What is claimed is:

1. An apparatus comprising:
a groundwater well;
a vaporizer for vaporizing LNG; and
an LNG tank.

2. An apparatus according to claim 1 further comprising a means for pumping groundwater from the groundwater well to the vaporizer.

3. An apparatus according to claim 1 further comprising a means for pumping the LNG from the LNG tank to the vaporizer.

4. An apparatus according to claim 1 further comprising a groundwater injection well.

5. An apparatus according to claim 4 further comprising a means for injecting groundwater from the vaporizer into the groundwater injection well.

6. An apparatus according to claim 2 wherein the means for pumping groundwater is selected from the group consisting of electrical submersible pumps, surface driven pumps, and combinations thereof.

7. An apparatus according to claim 1 further comprising a natural gas pipeline.

8. An apparatus according to claim 1 wherein the vaporizer is selected from the group consisting of open rack vaporizers, shell-and-tube vaporizers, and combinations thereof.

9. An apparatus according to claim 5 wherein the means for injecting groundwater comprises a water injection pump.

10. An apparatus according to claim 3 wherein the means for pumping the LNG comprises a low pressure pump.

11. An apparatus according to claim 10 wherein the means for pumping the LNG further comprises a high pressure pump.

12. An apparatus according to claim 11 wherein the high pressure pump is located between the low pressure pump and the vaporizer.

13. An apparatus according to claim 1 wherein the heat from the groundwater vaporizes the LNG in the vaporizer to provide for natural gas.

14. An apparatus according to claim 1 wherein the groundwater well is located at a groundwater well location selected from the group consisting of onshore, offshore, and combinations thereof.

15. An apparatus according to claim 4 wherein the groundwater injection well is located at a groundwater injection well location selected from the group consisting of onshore, offshore, and combinations thereof.

16. A process comprising vaporizing LNG in a vaporizer using groundwater.

17. A process according to claim 16 wherein the groundwater is from a groundwater well.

18. A process according to claim 17 further comprising pumping the groundwater from the groundwater well to the vaporizer.

19. A process according to claim 18 further comprising injecting the groundwater from the vaporizer into a groundwater injection well.

20. A process according to claim 19 wherein the groundwater well is at a groundwater well location selected from the group consisting of onshore, offshore, and combinations thereof and further wherein the groundwater injection well is at a groundwater injection well location selected from the group consisting of onshore, offshore, and combinations thereof.
